(19) United States
(12) Patent Application Publication
(10) Pub. No.: US 2012/0072024 A1
(43) Pub. Date: Mar. 22, 2012

(54) TELEROBOTIC SYSTEM WITH DUAL APPLICATION SCREEN PRESENTATION

(76) Inventors: Yulun Wang, (US); Charles S. Jordan, (US); Jonathan Southard, Santa Barbara, CA (US); Marco Pinter, Santa Barbara, CA (US)

(21) Appl. No.: 13/277,449

(22) Filed: Oct. 20, 2011

Related U.S. Application Data
(63) Continuation-in-part of application No. 12/345,161, filed on Dec. 29, 2008.
Application No. 12/345,161 is a continuation of application No. 12/148,247, filed on Apr. 16, 2008.
Application No. 12/148,247 is a continuation of application No. 11/835,628, filed on Aug. 8, 2007.
Application No. 11/835,628 is a division of application No. 11/138,595, filed on May 25, 2005, now Pat. No. 7,310,570.
Application No. 11/138,595 is a continuation of application No. 10/206,457, filed on Jul. 25, 2002, now Pat. No. 6,925,357.

(51) Int. Cl. B25J 13/06; B25J 19/04

(52) U.S. Cl. 700/259; 901/47

(57) ABSTRACT

A robot system that includes a robot and a remote station. The remote station may be a personal computer coupled to the robot through a broadband network. A user at the remote station may receive both video and audio from a camera and a microphone of the robot, respectively. The remote station may include a visual display that displays both a first screen field and a second screen field. The first screen field may display a video image provided by a robot camera. The second screen field may display information such as patient records. The information from the second screen field may be moved to the first screen field and also transmitted to the robot for display by a robot monitor. The user at the remote station may annotate the information displayed by the robot monitor to provide a more active video-conferencing experience.

### CROSS REFERENCE TO RELATED APPLICATIONS

This application is a continuation-in-part of application Ser. No. 12/345,161 filed Dec. 29, 2008, pending; which is a continuation of application Ser. No. 12/148,247, filed on Apr. 16, 2008, pending; which is a continuation of application Ser. No. 11/835,628, filed on Aug. 8, 2007, pending; which is a divisional of application Ser. No. 11/138,595, filed May 25, 2005, now U.S. Pat. No. 7,310,570 issued Dec. 18, 2007; which is a continuation of U.S. patent application Ser. No. 10/206,457, filed Jul. 25, 2002, now U.S. Pat. No. 6,925,357 issued Aug. 2, 2006.

### BACKGROUND OF THE INVENTION

1. Field of the Invention

The subject matter disclosed generally relates to the field of mobile two-way teleconferencing.

2. Background Information

There is a growing need to provide remote health care to patients that have a variety of ailments ranging from Alzheimers to stress disorders. To minimize costs it is desirable to provide home care for such patients. Home care typically requires a periodic visit by a health care provider such as a nurse or some type of assistant. Due to financial and/or staffing issues the health care provider may not be there when the patient needs some type of assistance. Additionally, existing staff must be continuously trained, which can create a burden on training personnel. It would be desirable to provide a system that would allow a health care provider to remotely care for a patient without being physically present.

Robots have been used in a variety of applications ranging from remote control of hazardous material to assisting in the performance of surgery. For example, U.S. Pat. No. 5,762,458 issued to Wang et al. discloses a system that allows a surgeon to perform minimally invasive medical procedures through the use of robotically controlled instruments. One of the robotic arms in the Wang system moves an endoscope that has a camera. The camera allows a surgeon to view a surgical area of a patient.

Tele-robots such as hazardous waste handlers and bomb detectors may contain a camera that allows the operator to view the remote site. Canadian Pat. No. 2289697 issued to Treviranus, et al. discloses a teleconferencing platform that has both a camera and a monitor. The platform includes mechanisms to both pivot and raise the camera and monitor. The Treviranus patent also discloses embodiments with a mobile platform, and different mechanisms to move the camera and the monitor.

There has been marketed a mobile robot introduced by InTouch Technologies, Inc., the assignee of this application, under the trademarks COMPANION and RP-6. The InTouch robot is controlled by a user at a remote station. The remote station may be a personal computer with a joystick that allows the user to remotely control the movement of the robot. Both the robot and remote station have cameras, monitors, speakers and microphones to allow for two-way video/audio communication.

U.S. Pat. Application Pub. No. US 2001/0054071 filed in the name of Loeb, discloses a video-conferencing system that includes a number of graphical user interfaces (“GUIs”) that can be used to establish a video-conference. One of the GUIs has an icon that can be selected to make a call. The Loeb application discloses stationary video-conferencing equipment such as a television. There is no discussion in Loeb about the use of robotics.

### BRIEF SUMMARY OF THE INVENTION

A robot system that includes a remote station and a robot. The remote station includes a visual display that displays a first screen field and a second screen field.

### BRIEF DESCRIPTION OF THE DRAWINGS

FIG. 1 is an illustration of a robotic system;

FIG. 2 is a schematic of an electrical system of a robot;

FIG. 3 is a further schematic of the electrical system of the robot;

FIG. 4 is a display user interface of a remote station having a first screen field and a second screen field;

FIG. 5 is a display user interface showing a first screen field;

FIG. 6 is a display user interface showing a portion of the second screen field being highlighted;

FIG. 7 is a display user interface showing the highlighted portion of the second screen transferred to the first screen;

FIG. 8 is a display user interface showing the highlighted portion of the screen shared with the robot monitor;

FIG. 9 is a display user interface showing a live robot camera feed;

FIG. 10 is a display user interface showing a live remote station camera feed.

### DETAILED DESCRIPTION

Disclosed is a robot system that includes a robot and a remote station. The remote station may be a personal computer coupled to the robot through a broadband network. A user at the remote station may receive both video and audio from a camera and a microphone of the robot, respectively. The remote station may include a visual display that displays both a first screen field and a second screen field. The first screen field may display a video image provided by a robot camera. The second screen field may display information such as patient records. The information from the second screen field may be moved to the first screen field and also transmitted to the robot for display by a robot monitor. The user at the remote station may annotate the information displayed by the robot monitor to provide a more active video-conferencing experience.

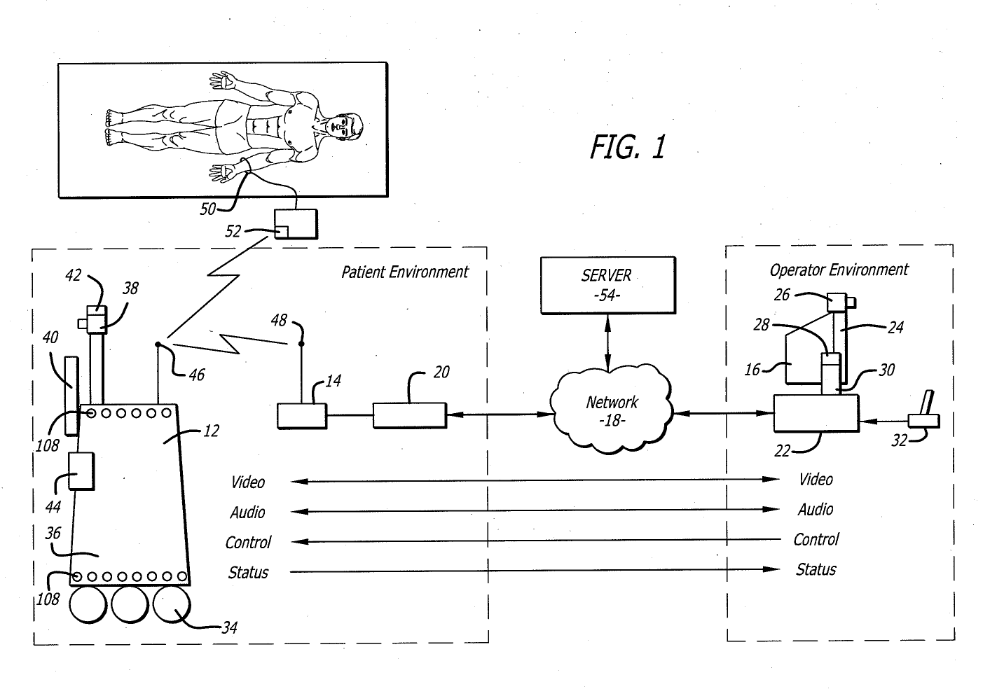

Referring to the drawings more particularly by reference numbers, FIG. 1 shows a system 10. The robotic system includes a robot 12, a base station 14 and a remote control station 16. The remote control station 16 may be coupled to the base station 14 through a network 18. By way of example, the network 18 may be either a packet switched network such as the Internet, or a circuit switched network such has a Public Switched Telephone Network (PSTN) or other broadband system. The base station 14 may be coupled to the network 18 by a modem 20 or other broadband network interface device. By way of example, the base station 14 may be a wireless router. Alternatively, the robot 12 may have a direct connection to the network thru for example a satellite.

The remote control station 16 may include a computer 22 that has a monitor 24, a camera 26, a microphone 28 and a speaker 30. The computer 22 may also contain an input device 32 such as a joystick or a mouse. The control station 16 is typically located in a place that is remote from the robot 12. Although only one remote control station 16. is shown, the system 10 may include a plurality of remote stations. In general any number of robots 12 may be controlled by any number of remote stations 16 or other robots 12. For example, one remote station 16 may be coupled to a plurality of robots 12, or one robot 12 may be coupled to a plurality of remote stations 16, or a plurality of robots 12.

Each robot 12 includes a movement platform 34 that is attached to a robot housing 36. Also attached to the robot housing 36 are a camera 38, a monitor 40, a microphone(s) 42 and a speaker(s) 44. The microphone 42 and speaker 30 may create a stereophonic sound. The robot 12 may also have an antenna 46 that is wirelessly coupled to an antenna 48 of the base station 14. The system 10 allows a user at the remote control station 16 to move the robot 12 through operation of the input device 32. The robot camera 38 is coupled to the remote monitor 24 so that a user at the remote station 16 can view a patient. Likewise, the robot monitor 40 is coupled to the remote camera 26 so that the patient may view the user. The microphones 28 and 42, and speakers 30 and 44, allow for audible communication between the patient and the user.

The remote station computer 22 may operate Microsoft OS software and WINDOWS XP or other operating systems such as LINUX. The remote computer 22 may also operate a video driver, a camera driver, an audio driver and a joystick driver. The video images may be transmitted and received with compression software such as MPEG CODEC.

The robot 12 may be coupled to one or more medical monitoring devices 50. The medical monitoring device 50 can take medical data from a patient. By way of example, the medical monitoring device 50 may be a stethoscope, a pulse oximeter and/or an EKG monitor. The medical monitoring device 50 may contain a wireless transmitter 52 that transmits the patient data to the robot 12. The wirelessly transmitted data may be received by antennae 46, or a separate antennae (not shown). The robot 12 can then transmit the data to the remote station 16.

The wireless transmission from the medical monitoring device 50 may be in accord with various wireless standards such as IEEE. The standard used to transmit data from the medical monitoring device 50 should not interfere with the wireless communication between the robot 12 and the base station 14. Although wireless transmission is shown and described, it is to be understood that the medical monitoring device 50 can be coupled to the robot 12 by wires (not shown).

The remote station 16 may be coupled to a server 54 through the network 18. The server 54 may contain electronic medical records of a patient. By way of example, the electronic medical records may include written records of treatment, patient history, medication information, a medical image, such as an e-ray, MRI or CT scan, EKGs, laboratory results, physician notes, etc. The medical records can be retrieved from the server 54 and displayed by the monitor 24 of the remote station 16. In lieu of, or in addition to, the medical records can be stored in the mobile robot 12. The remote station 16 may allow the physician to modify the records and then store the modified records back in the server 54 and/or robot 12.

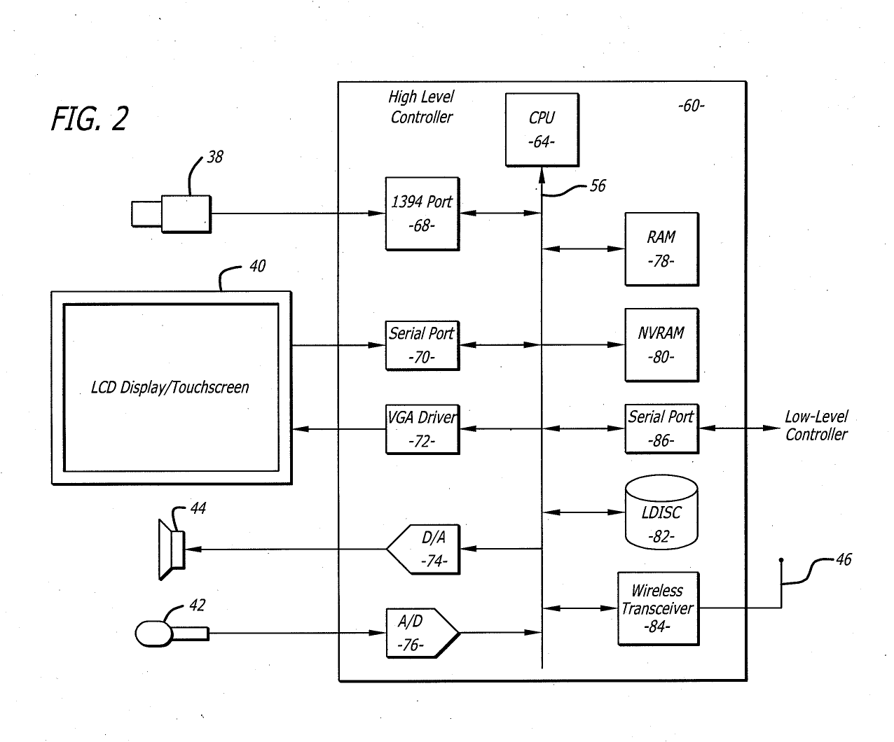

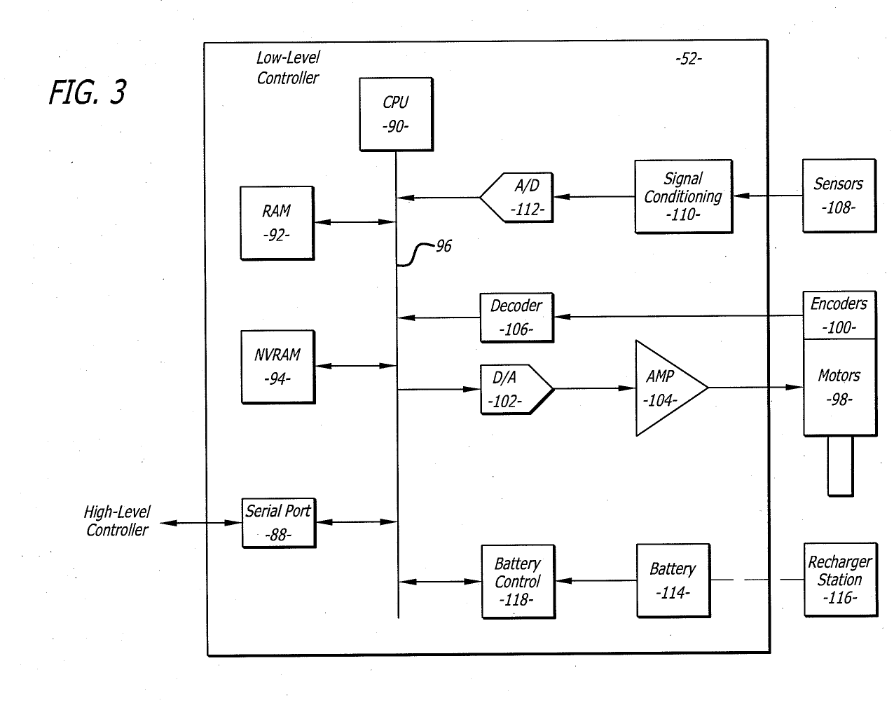

FIGS. 2 and 3 show an embodiment of a robot 12. Each robot 12 may include a high level control system 60 and a low level control system 62. The high level control system 60 may include a processor 64 that is connected to a bus 66. The bus is coupled to the camera 38 by an input/output (I/O) port 68, and to the monitor 40 by a serial output port 70 and a VGA driver 72. The monitor 40 may include a touchscreen function that allows the patient to enter input by touching the monitor screen.

The speaker 44 is coupled to the bus 66 by a digital to analog converter 74. The microphone 42 is coupled to the bus 66 by an analog to digital converter 76. The high level controller 60 may also contain random access memory (RAM) device 78, a non-volatile RAM device 80 and amass storage device 82 that are all coupled to the bus 72. The mass storage device 82 may contain medical files of the patient that can be accessed by the user at the remote control station 16. For example, the mass storage device 82 may contain a picture of the patient. The user, particularly a health care provider, can recall the old picture and make a side by side comparison on the monitor 24 with a present video image of the patient provided by the camera 38. The robot antennae 46 may be coupled to a wireless transceiver 84. By way of example, the transceiver 84 may transmit and receive information in accordance with IEEE 802.11b. The transceiver 84 may also process signals from the medical monitoring device in accordance with IEEE also known as Bluetooth. The robot may have a separate antennae to receive the wireless signals from the medical monitoring device.

The controller 64 may operate with a LINUX OS operating system. The controller 64 may also operate MS WINDOWS along with video, camera and audio drivers for communication with the remote control station 16. Video information may be transceived using MPEG CODEC compression techniques. The software may allow the user to send e-mail to the patient and vice versa, or allow the patient to access the Internet. In general the high level controller 60 operates to control communication between the robot 12 and the remote control station 16.

The high level controller 60 may be linked to the low level controller 62 by serial ports 86 and 88. The low level controller 62 includes a processor 90 that is coupled to a RAM device 92 and non-volatile RAM device 94 by a bus 96. Each robot 12 contains a plurality of motors 98 and motor encoders 100. The motors 98 can activate the movement platform and move other parts of the robot such as the monitor and camera. The encoders 100 provide feedback information regarding the output of the motors 98. The motors 98 can be coupled to the bus 96 by a digital to analog converter 102 and a driver amplifier 104. The encoders 100 can be coupled to the bus 96 by a decoder 106. Each robot 12 also has a number of proximity sensors 108 (see also FIG. 1). The position sensors 108 can be coupled to the bus 96 by a signal conditioning circuit 110 and an analog to digital converter 112.

The low level controller 62 runs software routines that mechanically actuate the robot 12. For example, the low level controller 62 provides instructions to actuate the movement platform to move the robot 12. The low level controller 62 may receive movement instructions from the high level controller 60. The movement instructions may be received as movement commands from the remote control station or another robot. Although two controllers are shown, it is to be understood that each robot 12 may have one controller, or more than two controllers, controlling the high and low level functions.

The various electrical devices of each robot 12 may be powered by a battery(ies) 114. The battery 114 may be recharged by a battery recharger station 116. The low level controller 62 may include a battery control circuit 118 that senses the power level of the battery 114. The low level controller 62 can sense when the power falls below a threshold and then send a message to the high level controller 60.

The system may be the same or similar to a robotic system provided by the assignee InTouch-Health, Inc. of Santa Barbara, Calif. under the name RP-6, which is hereby incorporated by reference. The system may also be the same or similar to the system disclosed in application Ser. No. 10/206,457 published on Jan. 29, 2004, which is hereby incorporated by reference.

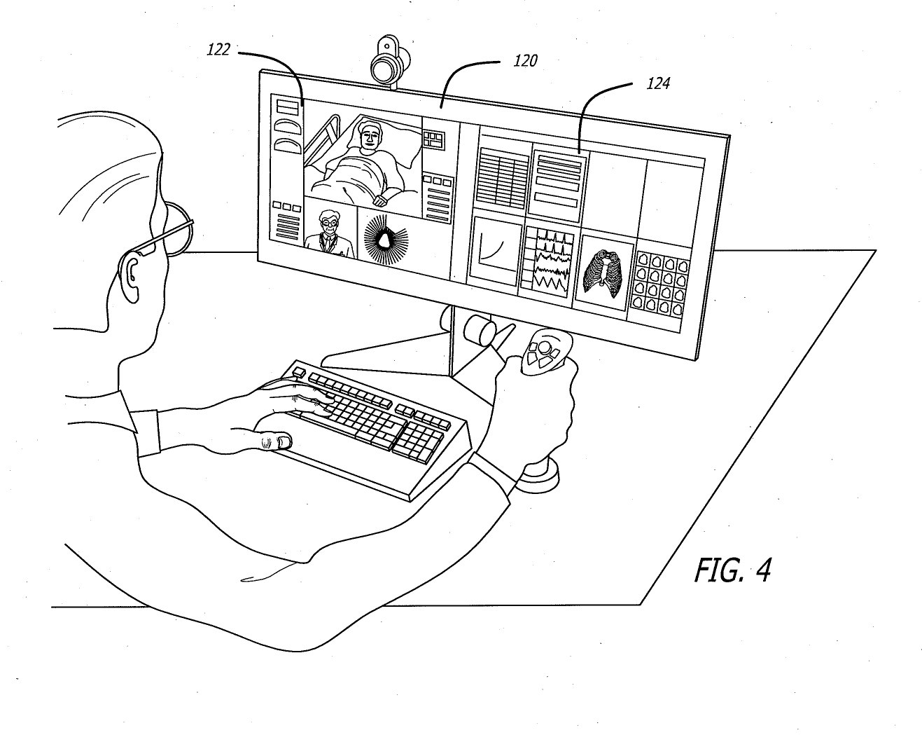

FIG. 4 shows a visual display 120 of the remote station. The visual display 120 displays a first screen field 122 and a second screen field 124. The two screen fields may be created by two different monitors. Alternatively, the two screen fields may be displayed by one monitor. The first and second screen fields 122 and 124 may be part of an application program(s) stored and operated by the computer 22 of the remote station 16.

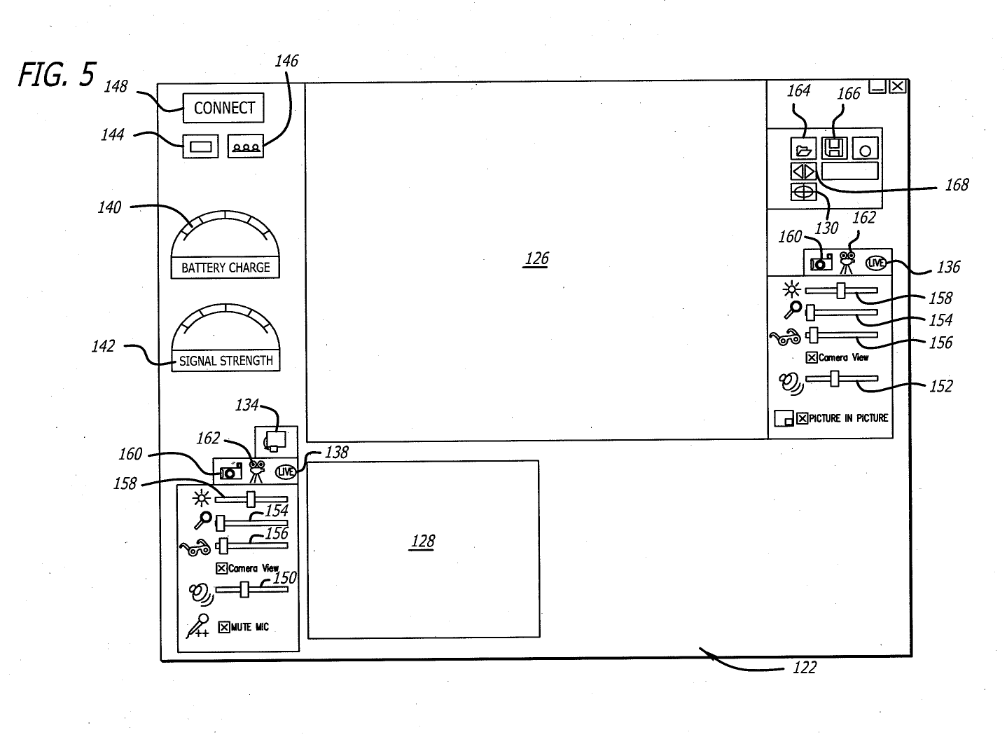

FIG. 5 shows a first screen field 122. The first screen field 122 may include a robot view field 126 that displays a video image captured by the camera of the robot. The first field 122 may also include a station view field 128 that displays a video image provided by the camera of the remote station. The first field 122 may have a capture button 130 that can be selected to move at least a portion of the record field 124 into the robot view field 126.

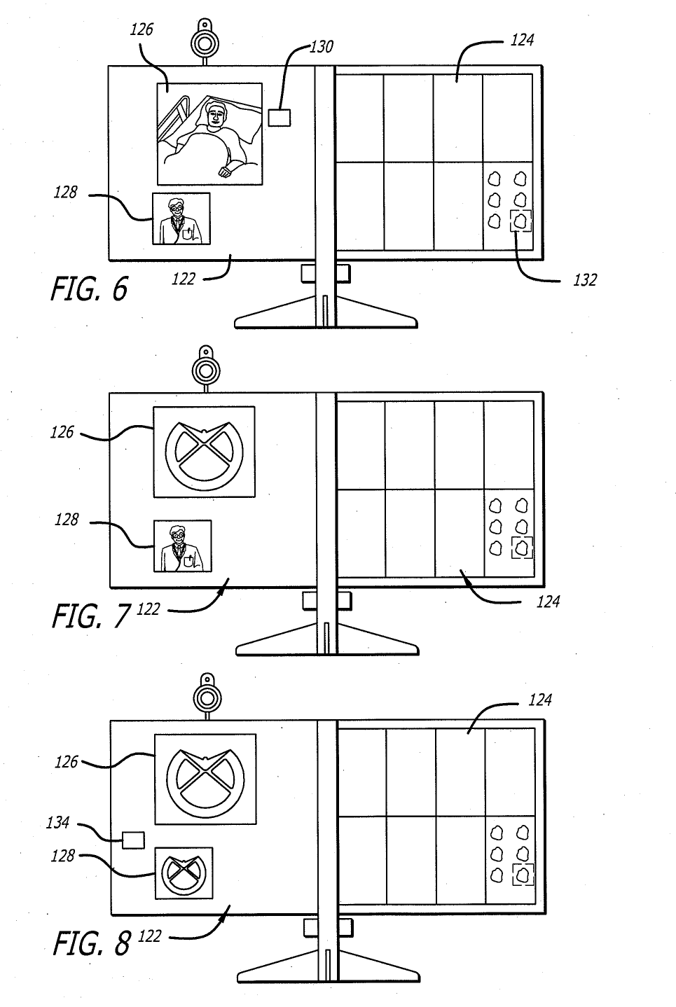

As shown in FIGS. 6 and 7, the highlighted portion 132 of the second screen 124 may be copied to the robot view field 126. By way of example, a graphical rectangle may be drawn around a portion of the second field through manipulation of a mouse. The ability to create the rectangle may be enabled by the selection of the capture button 130. The highlighted portion of the second screen 132 may automatically populate the robot view field 126 when the rectangle is completed by the user.

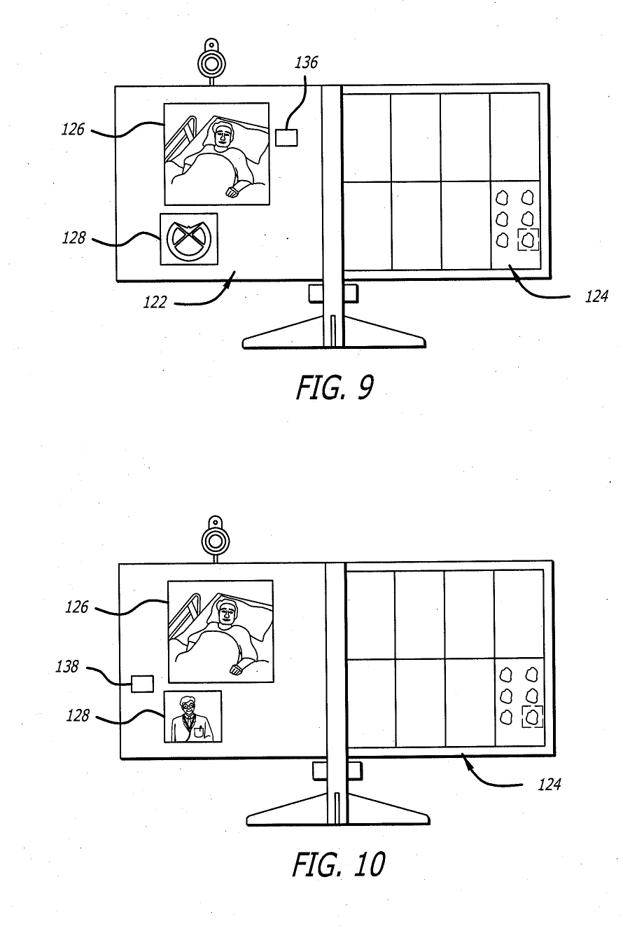

As shown in FIG. 8, the first screen field 122 may have a share button 134 that transfers the contents of the robot image field to the robot monitors. In this manner, the user can transfer the highlighted portion of the second screen field to the robot monitor. The transferred robot field contents are also displayed in the station view field 128. The user can switch back to a live feed from the robot camera by selecting the live button 136, as shown in FIG. 9. Likewise, the robot monitor may display a live feed of the remote station operator by selecting the live button 138, as shown in FIG. 10.

The visual display. 120 may include a graphical “battery meter” 140 that indicates the amount of energy left in the robot battery. A graphical “signal strength meter” 142 may indicate the strength of the wireless signal transmitted between the robot and the base station (see FIG. 1).

The first screen 122 may include a button 144 that can be used to select system settings. Button 146 can be selected to change the default robot in a new session. The button 146 can be used to select and control a different robot in a system that has multiple robots. The user can initiate and terminate a session by selecting button 148. The button 148 changes from CONNECT to DISCONNECT when the user selects the button to initiate a session.

Both the robot view field 126 and the station view field 128 may have associated graphics to vary the video and audio displays. Each field may have an associated graphical audio slide bar 150 to vary the audio level of the microphone and another slide bar 152 to vary the volume of the speakers.

The first field may have slide bars 154, 156 and 158 to vary the zoom, focus and brightness of the cameras, respectively. A still picture may be taken at either the robot or remote station by selecting one of the graphical camera icons 160. The still picture may be the image presented at the corresponding field 126 or 128 at the time the camera icon 160 is selected. Capturing and playing back video can be taken through graphical icons 162.

A still picture, file, etc. can be loaded from memory for viewing through selection of icon 164. An image, file, etc. can be stored by selecting buttons 166. The user can move through the still images in a slide show fashion by selecting graphical buttons 168.

The system may provide the ability to annotate the image displayed in field 126 and/or 128. For example, a doctor at the remote station may annotate some portion of the image captured by the robot camera. The annotated image may be stored by the system. The system may also allow for annotation of images sent to the robot through the share button 134. For example, a doctor may send a medical image, such as an x-ray, MRI or CT scan to the robot. The medical image is displayed by the robot screen. The doctor can annotate the medical image to point out a portion of the medical image to personnel located at the robot site. This can assist in allowing the doctor to instruct personnel at the robot site.

The second screen field may display a variety of different applications. For example, the second field 124 may display patient records, a medical image, etc. By way of example, the record field 124 may be a medical records program provided by Global Care Quest Corp. of Los Angeles, Calif.

The dual screen fields 122 and 124 allow the operator at the remote station to view the image provided by the robot on the first screen field 122 while simultaneously reviewing information on the second field screen 124. For example, a doctor may “visit” a patient through the robotic teleconferencing feature of the system. The first screen field 122 allows the doctor to view and interact with the patient. The doctor may also review patient information such as a medical image on the second screen field 124. Through the highlight and select features the doctor can display the medical image to the patient on the robot monitor. The doctor may point to certain areas of the medical image with the telestrating function.

Although a medical application is shown and described, the system can be used for any teleconference. For example, in a business environment a manager may “attend” a meeting by moving the robot into a meeting room. The manager may review documents, a power point presentation, drawings, etc. on the second screen field 124. The manager may transfer documents, etc. to the robot screen so that the remote participants can view the documents. In general the second screen may display any information, image, etc. that can be displayed by a computer monitor. The information may be provided by the servers shown in FIG. 1. Likewise, information such as still pictures and video taken by the robot camera can be transferred to the server. Information may also be retrieved and/or transmitted through the Internet.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A robot system, comprising:
a robot that has a monitor and a camera that captures a video image; and,
a remote station that is coupled to said robot, said remote station includes a visual display that displays said video image, a user interface element and a non-robot information, said remote station allows a highlighted portion of said non-robot information to be created by a user of said remote station while viewing said video image, and transmitted to said mobile robot, wherein said highlighted portion of non-robot information is displayed by said robot monitor in response to a selection of said user interface element.

2. The system of claim 1, wherein said remote station visual display includes a robot view field.

3. The system of claim 1, wherein non-robot information includes an application program.

4. The system of claim 3, wherein said application program displays said non-robot information.

5. The system of claim 1, wherein said remote station includes a user interface with a button that can be selected to cause transmission of said highlighted portion of non-robot information to said robot.

6. The system of claim 1, wherein a user can annotate said non-robot information displayed by said robot monitor.

7. The system of claim 1, wherein said non-robot information is a medical image.

8. The system of claim 1, wherein said non-robot information is a document.

9. The system of claim 4, further comprising a server that is coupled to said remote station and which provides said non-robot information.

10. The system of claim 1, wherein the captured video image is transmitted to said server.

11. A robot system, comprising:
a robot that has a monitor and a camera that captures a video image; and,
a remote station that is coupled to said robot, said remote station includes visual display means for displaying said video image, a user interface element, and a non-robot information, said remote station allows a highlighted portion of said non-robot information to be created by user of said remote station while viewing said video image, and transmitted to said mobile robot, wherein said highlighted portion of non-robot information is displayed by said robot monitor in response to a selection of said user interface element.

12. The system of claim 11, wherein said non-robot information includes an application program.

13. The system of claim 12, wherein said application program displays said non-robot information.

14. The system of claim 11, wherein said remote station includes a user interface with a button that can be selected to cause transmission of said highlighted portion of non-robot information to said robot.

15. The system of claim 11, wherein a user can annotate said non-robot information displayed by said robot monitor.

16. The system of claim 11, wherein said non-robot information is a medical image.

17. The system of claim 11, wherein said non-robot information is a document.

18. The system of claim 13, further comprising a server that is coupled to said remote station and which provides said non-robot information.

19. The system of claim 18 wherein the captured image is transmitted to said server.

20. A method for operating a robot system, comprising:
moving a robot that has a monitor and a camera with commands from a remote station;
capturing a video image with the camera;
transmitting the video image to a remote station;
displaying on a monitor of the remote station the video image and a non-robot information;
highlighting a portion of the non-robot information with input from a user of the remote station;
selecting a user interface element that is displayed by the remote station;
transmitting the highlighted portion of the non-robot information to the robot; and,
displaying the highlighted portion of the non-robot information on the robot monitor.

22. The method of claim 20, wherein the non-robot information includes an application program.

23. The method of claim 19, wherein the application program displays the non-robot information.

24. The method of claim 23, wherein the non-robot information is a medical image.

25. The method of claim 23, wherein the non-robot information is a document.

26. The method of claim 23, the non-robot information is transmitted from a server.

27. The method of claim 20, further comprising transmitting the video image to a server.
